(19) United States
(12) Patent Application Publication
(10) Pub. No.: US 2023/0239792 A1
(43) Pub. Date: Jul. 27, 2023

(54) SCELL DORMANCY INDICATION WHEN DRX IS NOT CONFIGURED FOR CONNECTED MODE UE

(71) Applicant: QUALCOMM Incorporated, San Diego, CA (US)

(72) Inventors: Huilin XU, Temecula, CA (US); Peng CHENG, San Diego, CA (US)

(21) Appl. No.: 17/996,229

(22) PCT Filed: Jun. 3, 2020
(86) PCT No.: PCT/CN2020/094220

§ 371 Date: Oct. 14, 2022

(51) Int. Cl. H04W 52/02

(52) U.S. Cl. CPC H04W 52/0229; H04W 52/0212

(57) ABSTRACT

Aspects of the present disclosure provide techniques that may allow a UE to receive and process downlink control information (DCI) that indicates dormancy behavior for one or more secondary cells when the UE does not have a CDRX mode configuration.

### INTRODUCTION

Aspects of the present disclosure relate to wireless communications, and more particularly, to techniques for handling indications to change secondary cell processing states.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, next generation NodeB (gNB or gNodeB), TRP, etc.). A BS or DU may communicate with a set of UEs on downlink channels (e.g., for transmissions from a BS or DU to a UE) and uplink channels (e.g., for transmissions from a UE to a BS or DU).

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

As the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between wireless communication devices.

Certain aspects provide a method for wireless communications by a user equipment. The method generally includes receiving from a network entity, while the UE is in a first mode associated with continuous physical downlink control (PDCCH) monitoring, indication of a change in dormancy behavior for one or more secondary cells (SCells) or SCell groups, and applying the indicated change in dormancy behavior.

Certain aspects provide a method for wireless communications by a network entity. The method generally includes providing, to a user equipment (UE) that is in a first mode associated with continuous physical downlink control (PDCCH) monitoring, an indication of a change in dormancy behavior for one or more secondary cells (SCells) or SCell groups, and applying the indicated change in dormancy behavior.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in which certain aspects of the present disclosure may be implemented.

FIG. 2 is a block diagram conceptually illustrating a design of an example a base station (BS) and user equipment (UE), in which certain aspects of the present disclosure may be implemented.

FIG. 3 illustrates an example discontinuous reception (DRX) scenario.

FIG. 4 illustrates example operations for wireless communication by a user equipment, in accordance with various aspects of the disclosure.

FIG. 5 illustrates example operations for wireless communication by a network entity, in accordance with various aspects of the disclosure.

FIG. 6 illustrates an example call flow diagram for processing signaling indicating changes to dormancy behavior in secondary cells (SCells), in accordance with various aspects of the disclosure.

FIGS. 7A & 7B illustrate example scenarios of changes to dormancy behavior in SCells, in accordance with various aspects of the disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for handling indications to change secondary cell processing states. In some cases, a UE that does not have a connected mode DRX configuration may still be able to receive and process SCell dormancy indications.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

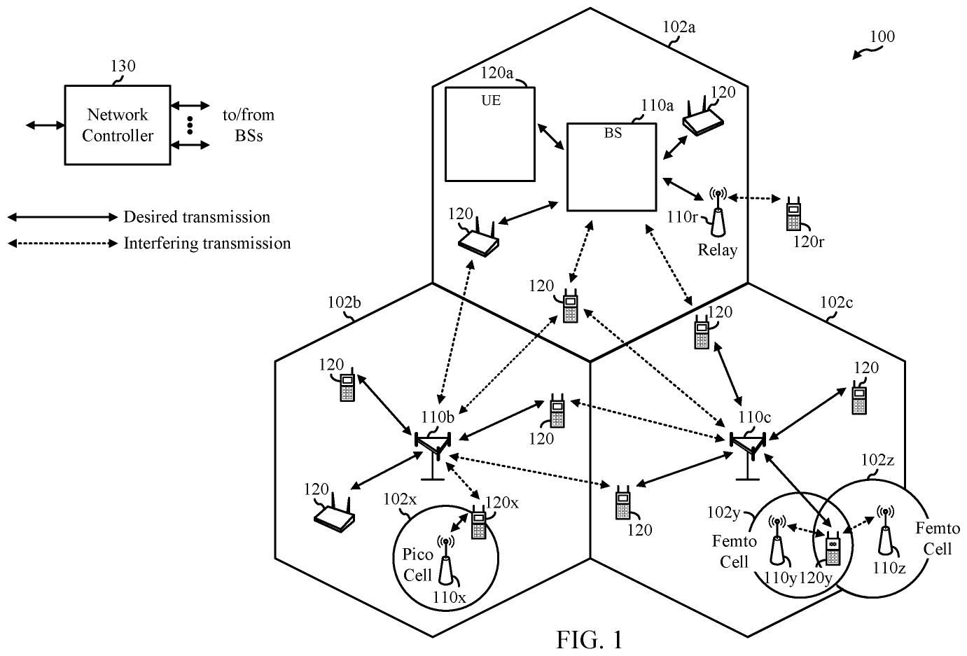

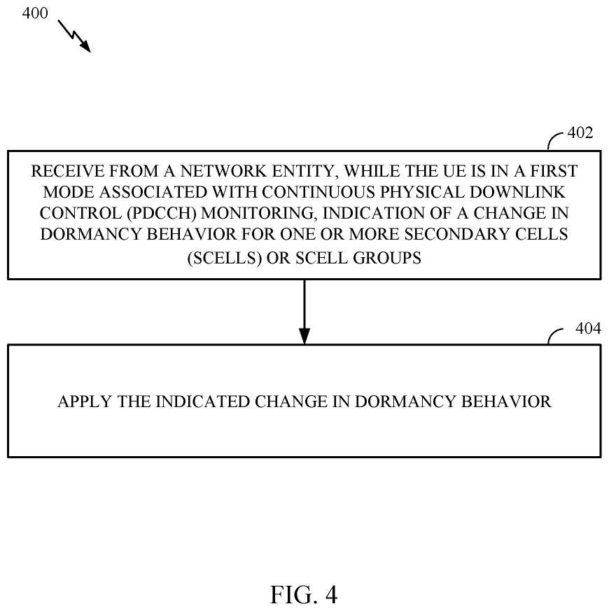

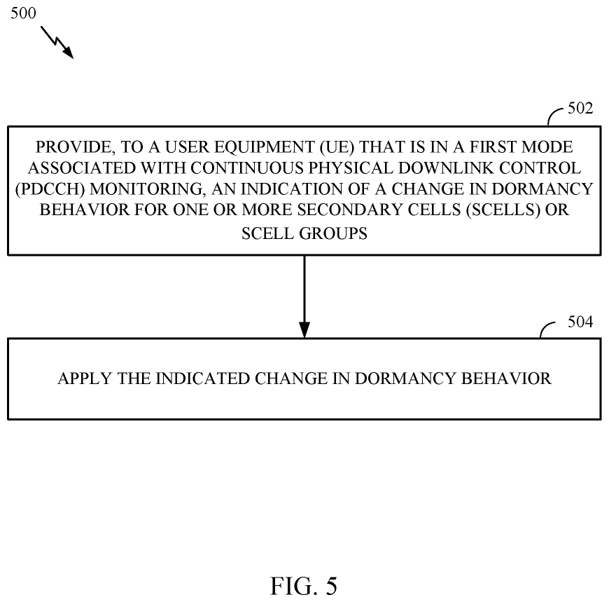

FIG. 1 illustrates an example wireless communication network 100 in which aspects of the present disclosure may be performed. For example, one or more UEs 120 in the network 100 may be configured to perform operations 400 of FIG. 4. Similarly, base stations 110 (e.g., gNBs) in the network 100 may be configured to perform operations 500 of FIG. 5.

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 20x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

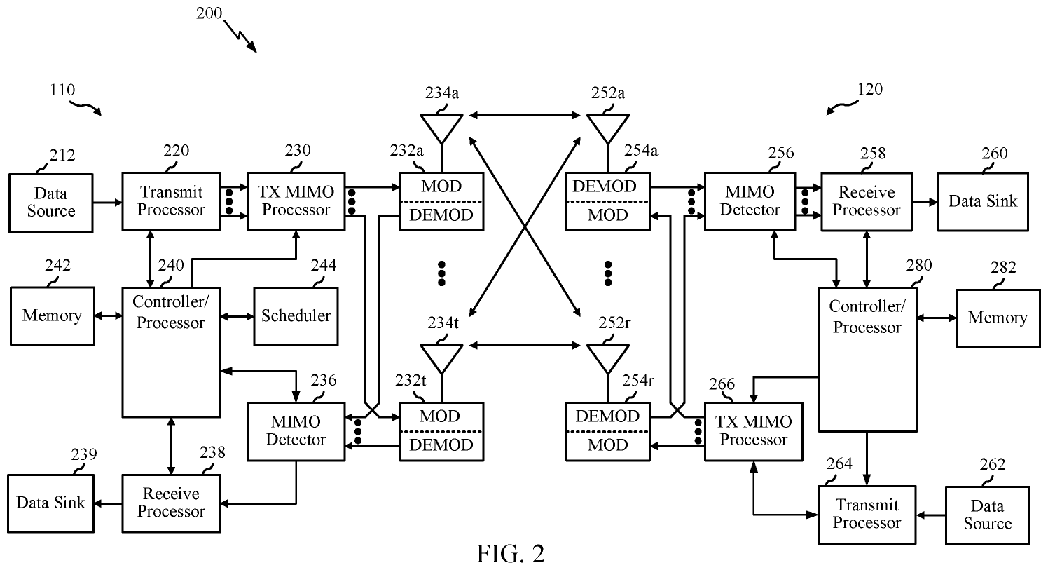

FIG. 2 illustrates example components of BS 110 and UE 120 (e.g., in the wireless communication network 100 of FIG. 1), which may be used to implement aspects of the present disclosure. For example, antennas 252, processors 266, 258, 264, and/or controller/processor 280 of the UE 120 may be configured to perform operations 400 of FIG. 4. Similarly, antennas 234, processors 220, 230, 238, and/or controller/processor 240 of the BS 110 may be configured to perform operations 500 of FIG. 5.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive downlink signals from the BS 110 or a parent IAB-node, or a child IAB-node may receive downlink signals from a parent IAB-node, and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120 or a child IAB-node, a transmit processor 264 may receive and process data (e.g., for the physical uplink shared channel (PUSCH) or the PSSCH) from a data source 262 and control information (e.g., for the physical uplink control channel (PUCCH) or the PSCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110 or a parent IAB-node.

At the BS 110 or a parent IAB-node, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The controller/processor 280 and/or other processors and modules at the UE 120 may perform or direct the execution of processes for the techniques described herein. The memories 242 and 282 may store data and program codes for BS 110 and UE 120, respectively. A scheduler 244 may schedule UEs for data transmission on the downlink and/or uplink.

### Example Scell Dormancy Indication when Drx is not Configured for Connected Mode UE

Carrier aggregation generally refers to the ability to combine two or more carriers into one data channel to enhance data capacity. In some cases, carrier aggregation may allow a UE to be configured with multiple serving cells. One special serving cell may be referred to as the primary cell (PCell). The other serving cells may be referred to as secondary cells (SCells).

In New Radio (NR) deployments, a new UE behavior is defined for an activated Scell, called the Scell dormancy-like behavior. Scell dormancy-like behavior is different from the LTE Scell dormant state. When an activated Scell is configured for dormancy-like behavior, UE activity is reduced on the Scell (e.g., for power saving). For example, when an SCell is configured with dormancy-like behavior, the UE may:

Not perform PDCCH monitoring;

Not PDSCH reception; and/or

Reduce C SI/measurement and/or reporting frequency.

The network can switch an Scell between non-dormancy-like behavior and dormancy-like behavior. When the Scell is configured for non-dormancy-like behavior, the UE has full utilization of the Scell as usual. When multiple SCells are configured to a UE, the dormancy indication can be applied to individual SCells or Scell groups.

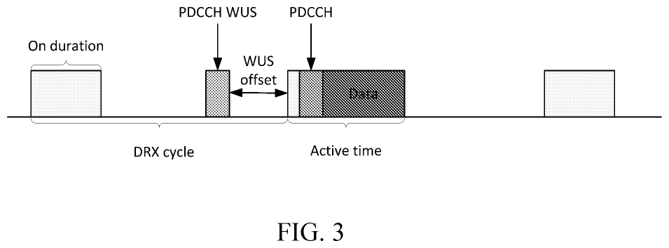

In some cases, a UE may be put in a Discontinuous reception (DRX) mode for power savings. As illustrated in FIG. 3, in DRX mode, the UE goes to sleep to save power and wakes up periodically to monitor the physical downlink control channel (PDCCH) for potential scheduled downlink reception and/or uplink transmission for the UE. Typically, if DRX is not configured, the UE is always ready to receive PDCCH.

As illustrated in FIG. 3, DRX consists of the sleep portion and the wakeup portion. The wakeup portion is called the “On Duration” where the UE monitors for a PDCCH transmission that schedules data. If PDCCH (carrying a DCI) is detected, the On Duration is extended. The duration after the UE wakes up (including the On Duration and the extended portion) is called “Active Time”.

In NR, a wake up signal (WUS) is defined which is monitored by the UE outside the Active Time. The WUS may be detected with relatively simple receiver components, allowing the UE to stay in a reduced power state. The WUS indicates whether the UE should wake up (more fully) for PDCCH monitoring.

In some cases, a PDCCH can contain an Scell dormancy indication field. If DRX is configured, there are various scenarios for sending such a PDCCH. According to a first scenario (Scenario 1), outside the Active Time, the PDCCH may be sent as the PDCCH WUS. According to a second scenario (Scenario 2), inside the Active Time, the PDCCH may or may not additionally schedule data.

The S cell dormancy indication field in the PDCCH may indicate dormancy (i.e., dormancy-like or non-dormancy-like) for each Scell individually or the field may indicate dormancy for each group of SCells individually (e.g., with the same behavior applied to each Scell in a group). In some cases, switching between dormancy-like behavior and non-dormancy-like behavior may be realized by bandwidth part (BWP) switching between a dormant BWP and a regular BWP that allows full utilization of the Scell.

In conventional systems (e.g., NR release 16) how to receive and process dormancy indication DCI is typically only defined when CDRX is configured for a UE. In other words, the DCI field with the SCell dormancy indication in DCI format 0_1 and 1_1 may only be provided on a primary cell within a DRX Active Time and when the UE is configured with at least two DL BWPs for an SCell.

Aspects of the present disclosure, however, provide techniques that may help define UE behavior for SCell dormancy indication when CDRX is not configured for a UE.

FIG. 4 illustrates example operations 400 for wireless communications by a user equipment (UE), in accordance with aspects of the present disclosure. For example, operations 400 may be performed by a UE 120 shown in FIGS. 1 and 2.

Operations 400 begin at 402, by receiving from a network entity, while the UE is in a first mode associated with continuous physical downlink control (PDCCH) monitoring, indication of a change in dormancy behavior for one or more secondary cells (SCells) or SCell groups. At 404, the UE applies the indicated change in dormancy behavior.

FIG. 5 illustrates example operations 500 for wireless communications by a network entity that may be considered complementary to operations 400 of FIG. 4. For example, operations 500 may be performed by a BS 110 (e.g., a gNB/PCell) shown in FIGS. 1 and 2 communicating with a UE 120 (performing operations 400 of FIG. 4).

Operations 500 begin at 502, by providing, to a user equipment (UE) that is in a first mode associated with continuous physical downlink control (PDCCH) monitoring, an indication of a change in dormancy behavior for one or more secondary cells (SCells) or SCell groups. At 504, the network entity applies the indicated change in dormancy behavior.

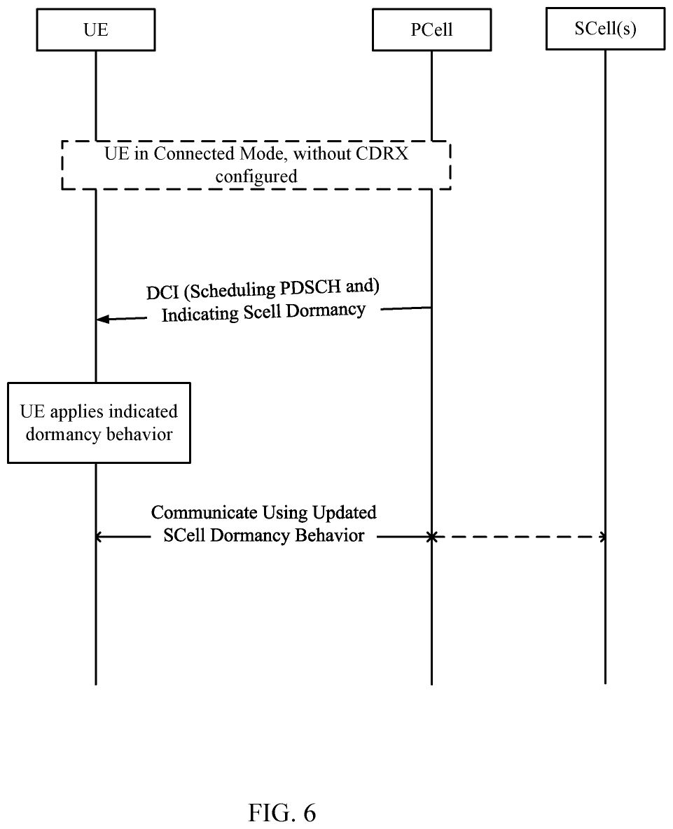

The operations of FIGS. 4 and 5 may be understood with reference to the call flow diagram of FIG. 6. In other words, the UE of FIG. 6 may perform operations 400 of FIG. 4, while the PCell may perform operations 500 of FIG. 5.

As illustrated, the UE is in Connected Mode without CDRX configured. Even so, the PCell is still able to send a DCI indicating a SCell Dormancy. The UE applies the indicated dormancy behavior (e.g., with one or multiple of the SCells moving from dormancy to non-dormancy or from non-dormancy to dormancy) and communicates accordingly.

In this manner a UE may support a switch between dormancy behavior and non-dormancy behavior when CDRX is not configured to the UE. In some cases, the UE may receive a particular DCI format (e.g., DCI format 0_1 or 1_1) that includes a dormancy indication field for the switch between dormancy behavior and non-dormancy behavior. The DCI format may be received in a slot according to a search space set configuration for the particular DCI format.

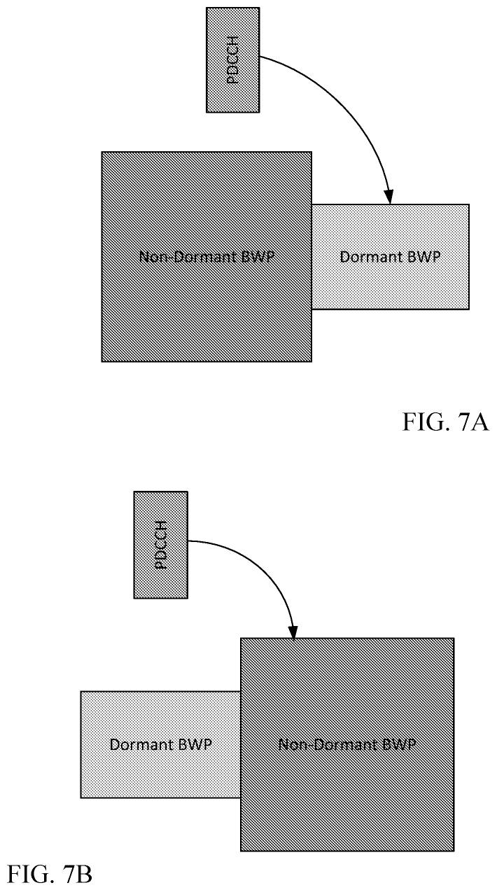

As illustrated in FIGS. 7A and 7B, the update may be applied to switch between dormant and non-dormant bandwidth parts (BWPs). As shown in FIG. 7A, the non-dormant BWP may or may not be the first non-dormant BWP. As shown in FIG. 7B, the non-dormant BWP may be the first non-dormant BWP.

In some cases, the UE may be configured with a dormant BWP and a non-dormant BWP associated with the dormancy behavior and non-dormancy behavior for a SCell when CDRX is not configured. The non-dormant BWP may be a first BWP that the UE operates in when it is switched from dormancy behavior to non-dormancy behavior on a SCell. According to one option (Option 1), the UE can be configured with a separate dormant BWP or non-dormant BWP that is different than a dormant BWP and non-dormant BWP for when CDRX is configured. According to another option (Option 2), the UE can be configured to use the same dormant BWP and non-dormant BWP as when CDRX is configured.

In some cases, the SCell dormancy indication field may be present in a particular DCI format (e.g., 0_1 or 1_1) under certain conditions. For example, the field may only be present when connected mode DRX is configured for the UE, and when the DCI format is carried by PDCCH on the primary cell within DRX Active Time and the UE is configured with at least two DL BWPs for an SCell. As another example, the field may only be present when connected mode DRX is not configured for the UE, when the DCI format is carried by PDCCH on the primary cell and the UE is configured with at least two DL BWPs for an SCell.

In some cases, a UE capability report signaling may be defined to indicate to the network whether the UE supports the SCell dormancy function when CDRX is not configured. Indication of this support may mean that the UE will support receiving the DCI format 0_1 or 1_1 that contains the “SCell dormancy indication” field and is able to apply the indicated behavior (e.g., perform switching between dormancy behavior and non-dormancy behavior).

In some cases, when connected mode DRX is not configured for a UE, the UE may not be required to receive certain DCI formats (e.g., DCI format 2_6) that contains an “SCell dormancy indication” field. For SCell dormancy in some cases, a UE may only receive a DCI format (e.g., 2_6) that contains a “SCell dormancy indication” field outside DRX active time

The techniques described herein may be used for various wireless communication technologies, such as 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably.

A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2).

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

New Radio (NR) is an emerging wireless communications technology under development in conjunction with the 5G Technology Forum (SGTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system. For example, in some cases, processors such as those shown in FIG. 2 may be configured to perform operations 400 of FIG. 4 and/or operations 500 of FIG. 5.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 4-5.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communication by a user equipment (UE), comprising:
receiving from a network entity, while the UE is in a first mode associated with continuous physical downlink control (PDCCH) monitoring, indication of a change in dormancy behavior for one or more secondary cells (SCells) or SCell groups; and
applying the indicated change in dormancy behavior.

2. The method of claim 1, wherein the first mode corresponds to mode in which connected mode discontinuous reception (CDRX) is not configured for the UE.

3. The method of claim 2, wherein the indication is received via a downlink control information (DCI) that includes a dormancy indication field for a switch between a dormancy behavior and a non-dormancy behavior.

4. The method of claim 3, wherein:
the DCI is of a particular DCI format; and
the DCI is received in a slot according to a search space set configuration for the particular DCI format.

5. The method of claim 2, wherein the UE is configured with at least one dormant bandwidth part (BWP) and at least one non-dormant BWP for a SCell associated with the dormancy behavior and non-dormancy behavior when CDRX is not configured for the UE.

6. The method of claim 5, wherein the non-dormant BWP comprises a first non-dormant BWP the UE operates in when switched from dormancy behavior to non-dormancy behavior on the associated SCell.

7. The method of claim 6, wherein the dormant BWP and first non-dormant BWP are configured separately for SCells.

8. The method of claim 5, wherein:
the UE is configured with at least one of a different dormant BWP or a different non-dormant BWP when CDRX is configured for the UE.

9. The method of claim 5, wherein:
the UE is configured with the same dormant BWP and same non-dormant BWP when CDRX is configured for the UE.

10. The method of claim 3, wherein
the DCI is of a particular DCI format; and
the dormancy indication field in present in the particular DCI format only when one or more conditions are met.

11. The method of claim 10, wherein:
when connected mode DRX is not configured for the UE, the dormancy indication field is only present when the particular DCI format is carried by PDCCH on a primary cell and the UE is configured with at least two downlink bandwidth parts (BWPs) for an SCell.

12. The method of claim 11, wherein:
when connected mode DRX is configured for the UE, the dormancy indication field is only present when the particular DCI format is carried by PDCCH on the primary cell within a DRX active time and the UE is configured with at least two DL BWPs for an SCell.

13. The method of claim 2, further comprising reporting, to the network entity, an indication that:
the UE supports receiving DCI with the dormancy indication field when CDRX is not configured for the UE; and
applying the change in behavior indicated by the dormancy indication field.

14. A method of wireless communication by a network entity, comprising:
providing, to a user equipment (UE) that is in a first mode associated with continuous physical downlink control (PDCCH) monitoring, an indication of a change in dormancy behavior for one or more secondary cells (SCells) or SCell groups; and
applying the indicated change in dormancy behavior.

15. The method of claim 14, wherein the first mode corresponds to mode in which connected mode discontinuous reception (CDRX) is not configured for the UE.

16. The method of claim 15, wherein the indication is provided via a downlink control information (DCI) that includes a dormancy indication field for a switch between a dormancy behavior and a non-dormancy behavior.

17. The method of claim 16, wherein:
the DCI is of a particular DCI format; and
the DCI is provided in a slot according to a search space set configuration for the particular DCI format.

18. The method of claim 15, wherein the UE is configured with at least one dormant bandwidth part (BWP) and at least one non-dormant BWP for a SCell associated with the dormancy behavior and non-dormancy behavior when CDRX is not configured for the UE.

19. The method of claim 18, wherein the non-dormant BWP comprises a first non-dormant BWP the UE operates in when switched from dormancy behavior to non-dormancy behavior on the associated SCell.

20. The method of claim 19, wherein the dormant BWP and first non-dormant BWP are configured separately for SCells.

21. The method of claim 18, wherein:
the UE is configured with at least one of a different dormant BWP or a different non-dormant BWP when CDRX is configured for the UE.

22. The method of claim 18, wherein:
the UE is configured with the same dormant BWP and same non-dormant BWP when CDRX is configured for the UE.

23. The method of claim 16, wherein
the DCI is of a particular DCI format; and
the dormancy indication field in present in the particular DCI format only when one or more conditions are met.

24. The method of claim 23, wherein:
when connected mode DRX is not configured for the UE, the network entity only includes the dormancy indication field when the particular DCI format is carried by PDCCH on a primary cell and the UE is configured with at least two downlink bandwidth parts (BWPs) for an SCell.

25. The method of claim 24, wherein:
when connected mode DRX is configured for the UE, the network entity only includes the dormancy indication field when the particular DCI format is carried by PDCCH on the primary cell within a DRX active time and the UE is configured with at least two DL BWPs for an SCell.

26. The method of claim 15, comprising:
sending DCI that includes a dormancy indication field only after receiving, from the UE, an indication that the UE supports receiving DCI with the dormancy indication field when CDRX is not configured for the UE and applying the change in behavior indicated by the dormancy indication field.

27. An apparatus for wireless communication by a user equipment (UE), comprising:
means for receiving from a network entity, while the UE is in a first mode associated with continuous physical downlink control (PDCCH) monitoring, indication of a change in dormancy behavior for one or more secondary cells (SCells) or SCell groups; and
means for applying the indicated change in dormancy behavior.

28. An apparatus for wireless communication by a network entity, comprising:
means for providing, to a user equipment (UE) that is in a first mode associated with continuous physical downlink control (PDCCH) monitoring, an indication of a change in dormancy behavior for one or more secondary cells (SCells) or SCell groups; and
means for applying the indicated change in dormancy behavior.

29. An apparatus for wireless communication by a user equipment (UE), comprising:
a receiver configured to receive from a network entity, while the UE is in a first mode associated with continuous physical downlink control (PDCCH) monitoring, indication of a change in dormancy behavior for one or more secondary cells (SCells) or SCell groups; and
at least one processor configured to apply the indicated change in dormancy behavior.

30. An apparatus for wireless communication by a network entity, comprising:
a transmitter configured to provide, to a user equipment (UE) that is in a first mode associated with continuous physical downlink control (PDCCH) monitoring, an indication of a change in dormancy behavior for one or more secondary cells (SCells) or SCell groups; and
at least one processor configured to apply the indicated change in dormancy behavior.
